(19) United States
(12) Patent Application Publication
(10) Pub. No.: US 2026/0348374 A1
(43) Pub. Date: Nov. 5, 2026

(54) DRIVE UNIT

(71) Applicant: HAMMELMANN GMBH, Oelde (DE)

(72) Inventors: Martin OBERSCHEIDT, Ennigerloh (DE); Fabian STOFFERS, Rheda-Wiedenbrück (DE)

(21) Appl. No.: 19/127,772

(22) PCT Filed: Nov. 7, 2023
(86) PCT No.: PCT/EP2023/080966

§ 371 Date: May 7, 2025

(30) Foreign Application Priority Data
Nov. 8, 2022 (DE) 10 2022 129 520.6

(51) Int. Cl. F04B 53/10; F04B 7/02

(52) U.S. Cl. CPC F04B 53/109; F04B 7/0216; F04B 53/1002

(57) ABSTRACT

A drive unit with a plunger arrangement is configured so that at least an opening of the inlet valve is controllable via the outlet valve and an opening and closing of the outlet valve is controllable via a valve control unit. In a working position the outlet valve is closed and the inlet valve is moved by the outlet valve into an open position such that fluid that is supplied via the high-pressure connection and is under high pressure can be supplied via the second working chamber to the first working chamber. In a non-working position the outlet valve is open and the inlet valve is closed such that fluid under low pressure can be discharged out of the first working chamber via the second working chamber and the low-pressure connection after the plunger is driven.

### BACKGROUND AND SUMMARY OF THE INVENTION

Exemplary embodiments of the present invention relate to a drive unit and to the use of such a drive unit.

In generic drive units, a crankshaft or the like is driven by one or more plungers. For their part, the plungers are driven by supplying a fluid under high pressure, which is admitted into the working chamber of a plunger arrangement. Once the plunger has been driven, the fluid, which has been reduced in pressure due to the enlargement of the working chamber, is forced back out of the working chamber via a pressure line when the plunger returns to its initial position. These plunger cycles are controlled via a valve arrangement with an inlet and an outlet valve, which are controlled via a valve control system.

Usually, separate inlet and outlet valves are used for this purpose, each of which is controlled separately via the valve control unit.

Exemplary embodiments of the present invention are directed to a drive unit of the same type with reduced energy input for the control system.

The drive unit according to the invention has a plunger arrangement with a first working chamber and a plunger arranged in the first working chamber so as to be axially movable back and forth.

The drive unit also has a valve housing with a high-pressure connection and a low-pressure connection. A valve seat ring is arranged in the valve housing, having a second working chamber fluidically connected to the first working chamber, a high-pressure valve seat open to the latter and a low-pressure valve seat open to the latter.

An inlet valve is arranged between the high-pressure connection and the valve seat ring on the high-pressure valve seat.

An outlet valve is arranged between the low-pressure connection and the valve seat ring on the low-pressure valve seat.

At least one opening of the inlet valve can be controlled via the outlet valve and one opening and closing of the outlet valve can be controlled via a valve control unit.

In a working position, the outlet valve is closed and the inlet valve is moved into an open position by the outlet valve, so that high-pressure fluid supplied via the high-pressure connection can be fed to the first working chamber via the second working chamber and, in a non-working position, the outlet valve is open and the inlet valve is closed, so that low-pressure fluid can be discharged from the first working chamber via the second working chamber and the low-pressure connection after driving the plunger. The at least one plunger can be coupled to a consumer (in conjunction with a crankshaft).

With such a drive unit, it is possible to reduce the control energy for the valve arrangement of the inlet and outlet valve, as only the outlet valve needs to be actuated, which enables the inlet valve to be opened by a movement.

Furthermore, the compact arrangement of the inlet valve and the outlet valve makes it possible to make the drive unit smaller overall, which reduces the cost of the drive unit.

A further advantage of the drive unit is that with this design there are no deformable seals in the high-pressure region, which would lead to pressure-dependent friction and thus negatively influence the switching times of the valves or, if a labyrinth seal is selected, would generate additional leakages and reduce the efficiency.

According to an advantageous embodiment variant, the outlet valve has a tappet projecting into the second working chamber with a first sealing surface which, in the closed position of the tappet, rests against a sealing surface of the low-pressure valve seat. The inlet valve has a closing body with a second sealing surface which, in the closed position, rests against a sealing surface of the high-pressure valve seat.

When moving from an open position to the closed position, the tappet pushes the closing body from the closed position to its open position.

This mechanical coupling of the inlet valve with the outlet valve ensures reliable control of the inlet valve via the outlet valve.

According to an advantageous further development, in the closed position of the outlet valve, the first sealing surface of the tappet contacts the sealing surface of the low-pressure valve seat and, in the closed position of the inlet valve, the closing body contacts the sealing surface of the high-pressure valve seat.

According to an advantageous further development, the first sealing surface is designed as a conical annular surface connecting a first cylindrical tappet section extending through the second working chamber of the valve seat ring to a second cylindrical tappet section extending in the direction of the low-pressure connection.

The tappet is preferably guided exclusively in the region of a section of the tappet extending from the second cylindrical tappet section away from the valve seat ring in a low-pressure section of a housing body of the valve housing or in a guide bushing arranged in the housing body and is sealed in this region by an elastically deformable low-pressure seal or a low-pressure seal designed as a labyrinth seal.

This enables the exclusive arrangement of a deformable seal only in the low-pressure range to seal the tappet from the environment or the valve control.

According to a further advantageous further development, the inlet valve has an energy accumulator, in particular in the form of a compression spring, which presses the closing body into its closed position.

In particular, this means that the tappet of the outlet valve only has to rest against the closing body of the inlet valve without having to move it into its closed position.

According to a preferred embodiment variant, the closing body is designed as a ball, which has the particular advantage that little turbulence occurs due to the spherical surface when the inlet valve is open.

According to an advantageous embodiment variant, the outlet valve can be controlled pneumatically, electrically or hydraulically.

According to an advantageous embodiment variant, the valve control unit is coupled to a position sensor that detects the rotational position of the crankshaft and thus the position of the plunger in the first working chamber.

According to a further preferred embodiment variant, at least three, preferably five, plunger arrangements are provided, wherein each of the plungers is assigned an inlet valve and an outlet valve.

A use of a drive unit for pressure control in a hydraulic process assembly according to the invention is characterized in that the drive unit is designed as described above, wherein the drive unit is coupled to the process assembly in such a way that the plunger is coupled via a crankshaft to a generator for generating electrical energy or via a crankshaft to a mechanism using the rotary motion transmitted to the crankshaft.

### BRIEF DESCRIPTION OF THE DRAWING FIGURES

In the following, preferred exemplary embodiments are explained in more detail with reference to the accompanying drawings, wherein:

FIG. 1 shows a schematic sectional view of a variant of a drive unit according to the invention,

FIG. 2 shows a sectional enlargement of a section of the drive unit marked II, III in FIG. 1 to show the inlet valve and the outlet valve as well as the valve seat ring with the outlet valve closed and the inlet valve open, and

FIG. 3 shows a sectional enlargement corresponding to FIG. 2 with the outlet valve open and the inlet valve closed.

### DETAILED DESCRIPTION

In the following description of the figures, terms such as top, bottom, left, right, front, rear, etc. refer exclusively to the exemplary representation and position of the drive unit, plunger arrangement, plunger, valve seat ring, inlet valve, outlet valve and the like selected in the respective figures. These terms are not to be understood restrictively, i.e. these references may change due to different working positions or the mirror-symmetrical design or the like.

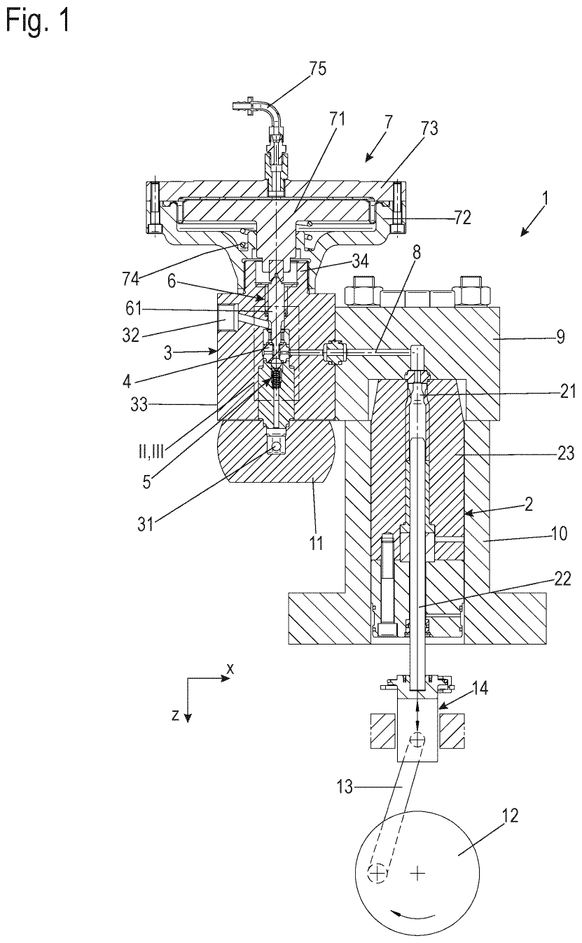

In FIG. 1, the reference sign 1 is used to designate a variant of a drive unit.

The drive unit 1 substantially consists of a plunger arrangement 2 with a plunger 22, which is arranged in a working chamber 21 of a plunger housing surrounding the plunger 22 so that it can move back and forth axially in the direction of its longitudinal axis, coaxially in the exemplary embodiment shown. The plunger 22 with the plunger housing 23 is accommodated in a plunger frame 10.

It is also conceivable to design the drive unit 1 with several such plunger arrangements, in which the plungers are preferably arranged in a row or several rows next to each other.

A crankshaft 12 or the like is preferably connected in the region of one end of the plunger 22, so that the movement of the plunger 22 enables the direct or indirect drive of a consumer. The crankshaft 12 is coupled to the plunger 22 via a connecting rod 13 and a coupling piece 14 attached to the connecting rod 13.

It is also conceivable to use the drive unit 1 for energy recovery, in which a fluid brought to high pressure in a preceding process is fed into the drive unit 1 and a generator, for example, is driven via the plunger driven by the high pressure and the crankshaft connected to the plunger, which converts the energy released by the expansion of the fluid under high pressure into electricity.

The first working chamber 21 of the plunger arrangement 2 is connected to a high-pressure line 8 arranged in a connecting frame 9, which in turn opens into a valve housing 3.

As shown in FIG. 1, the valve housing 3 has a housing body 33, to the underside of which a high-pressure connection 31 is connected. The high-pressure connection 31 is accommodated in a further frame 11, which is attached to the housing body 33 of the valve housing 3.

The housing body 33 of the valve housing 3 itself also has a low-pressure connection 32.

A valve seat ring 4 is arranged in a cavity of the housing body 33.

The valve seat ring 4 has a second working chamber 41 fluidically connected to the first working chamber 21, a high-pressure valve seat 42 open to this second working chamber 41 and a low-pressure valve seat 43 open to the second working chamber 41.

An inlet valve 5 is arranged between the high-pressure connection 31 and the valve seat ring 4 on the high-pressure valve seat 41.

An outlet valve 6 is arranged between the low-pressure connection 32 and the valve seat ring 4 on the low-pressure valve seat 43.

The inlet valve 5 is opened by the movement of the outlet valve 6.

The outlet valve 6 is opened and closed via a valve control unit 7, shown as an example in FIG. 1. A separate valve control unit for opening or closing the inlet valve 5 is not provided.

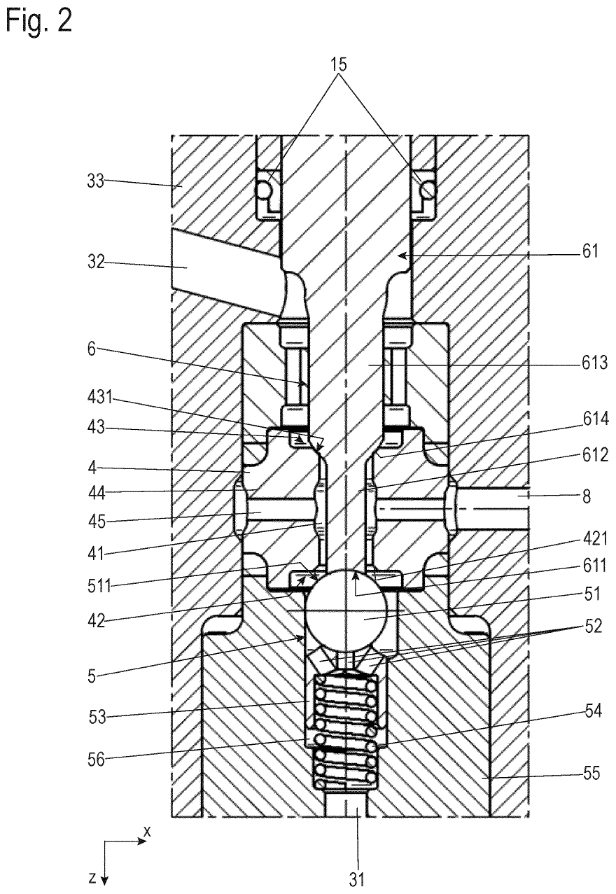

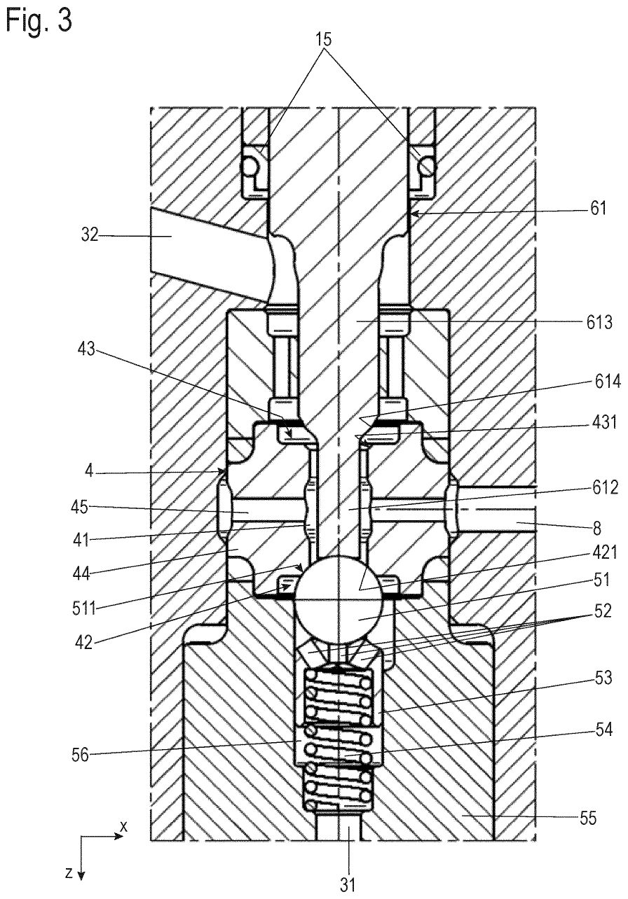

Both the high-pressure valve seat 42 and the low-pressure valve seat 43 in the embodiment variant shown here according to FIGS. 2 and 3 are designed as approximately annular recesses enclosing the second working chamber 41, with respective sealing surfaces 421, 431, which together with the inlet valve 5 or the outlet valve 6 block or release the flow of the fluid.

In the embodiment variant shown here, the outlet valve 6 has a tappet 61 projecting into the second working chamber 41, on the outer surface of which a first sealing surface 614 is integrally formed, which in the closed position of the tappet 61 lies directly against the sealing surface 431 of the low-pressure valve seat 43, i.e., to seal the second working chamber 41 on the low-pressure side, the tappet 61 lies directly against the valve seat ring 4 (the sealing surface 431 of the low-pressure valve seat 43 of the valve seat ring 4).

In the embodiment variant shown here, the first sealing surface 614 is designed as a conical annular surface connecting a first cylindrical tappet section 612 extending through the second working chamber 41 of the valve seat ring 4 with a second cylindrical tappet section 613 extending in the direction of the low-pressure connection 32.

An end face 611 of the tappet 61 is designed to be adapted to a contact surface of a closing body 51 of the inlet valve 5.

A portion of the tappet 61 remote from the first tappet section 612 and extending from the second cylindrical tappet section 613 is guided exclusively in a low-pressure section of the housing body 33 of the valve housing 3 or preferably in a guide bushing arranged in the housing body 33 and sealed by an elastically deformable low-pressure seal 15.

The low-pressure seal can also be designed as a labyrinth seal to reduce the friction component of the valve circuit.

The low-pressure section of the housing body 33 is understood to be the section of the housing body 33 that is not exposed to high pressure. As can be seen in FIGS. 2 and 3, this low-pressure section extends above the low-pressure valve seat 43 in the direction of the low-pressure connection 32 and beyond this into the region of the housing body 33 that guides the tappet 61.

The preferably spherical closing body 51 is pressed against the contact surface 611 of the tappet 61 from the side facing away from the tappet 61 by an energy accumulator holder pretensioned with a compression spring or another energy accumulator 54.

As shown in FIG. 1, the valve control unit 7 is preferably designed as a pneumatic control unit, having a compressed air inlet 75, which pushes a disk 71 downwards relative to a cover 73 when compressed air is admitted, wherein the disk 71 drives the tappet 61 and thus closes the outlet valve and simultaneously opens the inlet valve.

If the compressed air is released again to open the outlet valve 6, the disk 71 driving the tappet 61 is pressed back into its initial position against the cover 73 by a compression spring 74 in the embodiment variant shown here.

The valve control unit 7 preferably has a housing part 72 with an internal thread, which is screwed onto an external thread of a section 34 of the valve housing 3. A flange connection between the valve control unit 7 and the valve housing 3 is also conceivable, for example.

As an alternative to the spherical closing body 51, a cylindrical or conical closing body 51 is also conceivable.

The energy accumulator 54, designed here as a compression spring, is accommodated in a cylindrical recess in the energy accumulator holder and is supported on a step of a closing body receptacle 56 in a valve retaining body 55.

In a conceivable embodiment variant in which the closing body 51 is connected directly to the tappet 61, an energy accumulator unit 54 is not necessarily required. In this case, the compression spring 74 acting on the disk 71 of the valve control unit 7 can assume this function.

The closing body receptacle 56 is fluidically connected to the high-pressure connection 31.

The fluid under high pressure can flow past the closing body 51 into the second working chamber 41 of the valve seat ring via the closing body receptacle 56 through passage openings 52 provided in the energy accumulator holder, provided that a second sealing surface 511 of the closing body 51 does not rest against the sealing surface 421 of the high-pressure valve seat 42, against which the closing body 51 is pressed with the aid of the force of the spring retainer.

In its position sealing the second working chamber 41, the closing body 51, like the first sealing surface 614 of the tappet 61, lies directly against the sealing surface 421 of the high-pressure valve seat 42 of the valve seat ring 4.

This means that no elastic sealing elements are installed within the high-pressure range, which would lead to pressure-dependent friction and thus have a negative effect on the switching times of the valves.

In order to drive the plunger 22 from its top dead center, shown in FIG. 1, in the first working chamber 21, the inlet valve 5 must be opened.

To open the inlet valve 5, the tappet 61 is pressed against the closing body 51 and pushes the closing body 51 downwards away from the sealing surface 421 of the high-pressure valve seat 42 against the force of the energy accumulator 54.

The inlet valve 5 is opened by the movement of the outlet valve 6.

The outlet valve 6 is opened and closed as described above via the valve control unit 7, shown as an example in FIG. 1.

The mechanical or geometric coupling of the tappet 61 of the outlet valve 6 with the closing body 51 of the inlet valve 5 makes it possible that in a working position, in which the plunger 22 drives a crankshaft by its movement with the aid of the high-pressure fluid fed into the first working chamber 21, the outlet valve 6 is closed and the inlet valve 5 is moved into an open position by the outlet valve 6, as shown in FIG. 2.

At bottom dead center of the plunger 2, the outlet valve 6 is relieved. As shown in FIG. 3, the outlet valve 6 is opened and the inlet valve 5 is closed so that fluid under low pressure can be discharged from the first working chamber 21 via the second working chamber 41 and the low-pressure connection 32 after the plunger 22 has been driven.

As a comparison of FIGS. 2 and 3 shows, when the outlet valve 6 is open, the conical ring-shaped first sealing surface 614 of the tappet 61 is not in contact with the sealing surface 431 of the low-pressure valve seat 43.

In this respect, the lowering of the tappet 61 in the Z-direction (as shown in FIG. 2) enables the outlet valve 6 to be closed at the same time as the inlet valve 5 is opened, with the closing body 51 pushed away from the sealing surface 421 of the high-pressure valve seat 42.

Furthermore, the design described above means that no moving components need to be sealed to the outside within the high-pressure region, so that dynamic sealing elements, in particular in the form of elastic sealing lips or labyrinth seals, can be dispensed with entirely within the high-pressure region.

The outlet valve 6 is preferably pneumatically, electrically or hydraulically controllable.

The drive unit 1 described above can be used in a first application for energy recovery in a hydraulic process setup for generating electrical energy. For this purpose, a generator for generating electrical energy is coupled to the at least one plunger 22 via the crankshaft 12.

In a second use of the drive unit 1, a mechanism utilizing the rotary motion transmitted to the crankshaft is coupled via the crankshaft 12. The mechanism utilizing the rotary motion can be a pump, for example, in which the plunger of the pump is coupled to the crankshaft 12.

Other consumers for utilizing the kinetic rotational energy generated by the drive unit 1 are also conceivable.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of Reference Signs

1 Drive unit
2 Plunger arrangement
21 First working chamber
22 Plunger
23 Plunger housing
3 Valve housing
31 High-pressure connection
32 Low-pressure connection
33 Housing body
34 Flange
4 Valve seat ring
41 Second working chamber
42 High-pressure valve seat
421 Sealing surface
43 Low-pressure valve seat
431 Sealing surface
44 Ring body
45 Cross bore
5 Inlet valve
51 Closing body
511 Second sealing surface
52 Passage opening
53 Spring retainer
54 Energy accumulator
55 Valve retaining body
56 Closing body receptacle
6 Outlet valve
61 Tappet
611 Front face
612 First tappet section
613 Second tappet section
614 First sealing surface
7 Valve control unit
71 Disk
72 Flange
73 Cover
74 Compression spring
75 Compressed air inlet
8 High-pressure line
9 Connecting frame
10 Plunger frame
11 Frame
12 Crankshaft
13 Connecting rod
14 Coupling piece
15 Low-pressure seal

1-11. (canceled)

12. A drive unit comprising:
a plunger arrangement comprising a first working chamber and a plunger, wherein the plunger is arranged in the first working chamber so as to be axially movable back and forth within the first working chamber;
a valve housing comprising a high-pressure connection and a low-pressure connection;
a valve seat ring arranged in the valve housing, wherein the valve seat ring comprises a second working chamber fluidically connected to the first working chamber, a high-pressure valve seat open to the second working chamber, and a low-pressure valve seat open to the second working chamber;
an inlet valve arranged between the high-pressure connection and the valve seat ring on the high-pressure valve seat; and
an outlet valve arranged between the low-pressure connection and the valve seat ring on the low-pressure valve seat,
wherein at least one opening of the inlet valve is controllable via the outlet valve,
wherein one opening and closing of the outlet valve is controllable via a valve control unit,
wherein, in a working position, the outlet valve is closed and the inlet valve is moved into an open position by the outlet valve so that high-pressure fluid supplied via the high-pressure connection is feedable to the first working chamber via the second working chamber and, in a non-working position, the outlet valve is open and the inlet valve is closed so that low-pressure fluid is dischargeable from the first working chamber via the second working chamber and the low-pressure connection after driving the plunger, and
wherein the plunger is couplable to a consumer.

13. The drive unit of claim 12, wherein
the outlet valve comprises a tappet projecting into the second working chamber with a first sealing surface, and, in a closed position of the outlet valve, the tappet rests against a sealing surface of the low-pressure valve seat, and
the inlet valve comprises a closing body with a second sealing surface, and, in a closed position of the inlet valve, the second sealing surface rests against a sealing surface of the high-pressure valve seat, and
when moving the closing body from an open position to the closed position of the inlet valve, the tappet pushes the closing body from a closed position of the closing body to an open position of the closing body.

14. The drive unit of claim 13, wherein, in the closed position of the outlet valve, the first sealing surface of the tappet contacts the sealing surface of the low-pressure valve seat and, in the closed position of the inlet valve, the closing body contacts the sealing surface of the high-pressure valve seat.

15. The drive unit of claim 14, wherein the first sealing surface is a conical annular surface connecting a first cylindrical tappet section extending through the second working chamber of the valve seat ring to a second cylindrical tappet section extending in a direction of the low-pressure connection.

16. The drive unit of claim 15, wherein the tappet is guided exclusively in a region of a section of the tappet extending from the second cylindrical tappet section away from the valve seat ring in a low-pressure section of a housing body of the valve housing or in a guide bushing arranged in the housing body and is sealed in a region of the guide bushing by an elastically deformable low-pressure seal or a low-pressure labyrinth seal.

17. The drive unit of claim 13, wherein the inlet valve comprises an energy accumulator configured to press the closing body into the closed position of the closing body.

18. The drive unit of claim 13, wherein the closing body is spherical, conical, or cylindrical.

19. The drive unit of claim 12, wherein the outlet valve is pneumatically, electrically, or hydraulically controllable.

20. The drive unit of claim 12, wherein the valve control unit is coupled to a position sensor providing a position of a rotational position of a drive shaft coupled to the plunger or of the plunger in the first working chamber.

21. The drive unit of claim 12, the plunger arrangement comprises at least three plunger arrangements, wherein each plunger of the three plunger arrangements is assigned a respective inlet valve and outlet valve.

22. A method comprising:
providing a drive unit comprising
a plunger arrangement comprising a first working chamber and a plunger, wherein the plunger is arranged in the first working chamber so as to be axially movable back and forth within the first working chamber;
a valve housing comprising a high-pressure connection and a low-pressure connection;
a valve seat ring arranged in the valve housing, wherein the valve seat ring comprises a second working chamber fluidically connected to the first working chamber, a high-pressure valve seat open to the second working chamber, and a low-pressure valve seat open to the second working chamber;
an inlet valve arranged between the high-pressure connection and the valve seat ring on the high-pressure valve seat; and
an outlet valve arranged between the low-pressure connection and the valve seat ring on the low-pressure valve seat,
wherein at least one opening of the inlet valve is controllable via the outlet valve,
wherein one opening and closing of the outlet valve is controllable via a valve control unit,
wherein, in a working position, the outlet valve is closed and the inlet valve is moved into an open position by the outlet valve so that high-pressure fluid supplied via the high-pressure connection is feedable to the first working chamber via the second working chamber and, in a non-working position, the outlet valve is open and the inlet valve is closed so that low-pressure fluid is dischargeable from the first working chamber via the second working chamber and the low-pressure connection after driving the plunger; and
coupling the plunger via a crankshaft to a generator configured to generate electrical energy or to a mechanism configured to use rotary motion transmitted to the crankshaft.
